(19) United States
(12) Patent Application Publication
(10) Pub. No.: US 2017/0140351 A1
(43) Pub. Date: May 18, 2017

(54) BIG DATA DISTRIBUTION BROKERAGE SYSTEM USING DATA VERIFICATION AND METHOD THEREOF

(71) Applicant: Electronics and Telecommunications Research Institute, Daejeon-si (KR)

(72) Inventor: Min Kyo IN, Daejeon-si (KR)

(73) Assignee: Electronics and Telecommunications Research Institute, Daejeon-si (KR)

(21) Appl. No.: 15/338,546

(22) Filed: Oct. 31, 2016

(30) Foreign Application Priority Data
Nov. 18, 2015 (KR) 10-2015-0162135
Sep. 22, 2016 (KR) 10-2016-0121623

(51) Int. Cl. G06Q 20/10; G06F 17/30

(52) U.S. Cl. CPC G06Q 20/102; G06F 17/30522

(57) ABSTRACT

A big data distribution brokerage system using data verification performing sales registration of big data, verification of the big data, generation of a sales list of the big data, and a payment processing so as to safely transact the big data when transacting large amounts of big data, and a method thereof are provided. The system includes a big data sales request registration unit, a big data verification unit, a big data sales list management unit, and a big data transaction management unit, and the system and method perform a series of operations using a big data distribution brokerage service in order to activate transaction of big data, do not separately store the big data possessed by a big data seller in the outside, and perform actual transaction of the big data between the seller and a purchaser.

### CROSS-REFERENCE TO RELATED APPLICATION(S)

This application claims priority from Korean Patent Application Nos. 10-2015-0162135 filed on Nov. 18, 2015, 10-2016-0121623 filed on Sep. 22, 2016, in the Korean Intellectual Property Office, the disclosure of which is incorporated herein by reference in its entirety.

### BACKGROUND

1. Field

The following description relates to a big data distribution brokerage service, and more particularly, to a big data distribution brokerage system performing sales registration of big data, verification of the big data, generation of a sales list of the big data, and a payment processing so as to safely transact the big data when transacting large amounts of big data, and a method thereof.

2. Description of Related Art

Recently, an attempt to find a new business through large amounts of data, that is, big data, is being performed in various fields.

However, conventionally, production, processing, and use of most of big data have been mainly performed inside an organization, but recently, a form in which many institutions or companies which are not directly related to production of data collect, process, and consume the big data is being developed, and thus, a need on distribution of the big data for connecting a production side of data and a purchase (consumption) side of the data is being increased. However, in the distribution of the big data, a formation of an ecosystem for transacting the big data is still in an insufficient stage since there are a fundamental difference and a problem with the conventional data distribution.

In order to transact the big data, large amounts of data should be able to be controlled unlike a general document (a video, a report, a paper, etc.), and a storage space suitable for storing the data is needed.

However, since all big data which is sold is stored in a brokerage server and is provided due to a characteristic of the big data, excessive costs are used, and particularly, the distribution of the big data using a manner of storing in a server side has many limitations when considering a security aspect.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a big data distribution brokerage system using data verification which performs a series of operations such as sales registration of big data, verification of the big data, a payment, etc. using a big data distribution brokerage service in order to activate transaction of big data, does not separately store the big data possessed by a big data seller in the outside, and performs actual transaction of the big data between the seller and a purchaser, and a method thereof.

In one aspect, a big data distribution brokerage system using data verification, includes: a big data sales request registration unit configured to register a big data seller using big data sales request information received from the big data seller; a big data verification unit configured to request basic metadata and sampling data of the big data from the registered big data seller, perform a verification on reliability of the big data by matching the basic metadata and the sampling data received in response to the request, and generate verification result information; a big data sales list management unit configured to generate big data sales list information using the verification result information and the big data sales request information when the reliability is recognized using the verification, and provide the generated big data sales list information to at least one purchaser; and a big data transaction management unit configured to determine a big data transmission method when a purchase request is received from the purchaser, and provide an online or offline path transmitting the big data possessed by the big data seller to the purchaser according to the determined big data transmission method.

According to an embodiment of the present invention, the big data verification unit may request structural characteristic information related to a structural characteristic of the big data from the registered big data seller, and determine types and sizes of basic metadata and sampling data of the big data requested to the registered big data seller according to the structural characteristic information.

According to an embodiment of the present invention, the big data verification unit may request structural characteristic information related to a structural characteristic of the big data from the registered big data seller, and determine a big data reliability verification method according to the structural characteristic information.

According to an embodiment of the present invention, the big data verification unit may perform the verification on the reliability of the big data every predetermined period, and update the generated verification result information.

According to an embodiment of the present invention, the big data sales list management unit may add evaluation of the purchaser of the big data who previously purchased in the big data sales list information.

According to an embodiment of the present invention, the big data transaction management unit may further include a transmission module support unit configured to provide a big data transmission module to servers of the big data seller and the purchaser when the big data transmission method is determined to be an online transmission.

According to an embodiment of the present invention, the big data transaction management unit may further include a payment processing unit configured to remit payment to the big data seller when the payment is received from the purchaser before transmitting the big data and the transmission of the big data is completed.

According to an embodiment of the present invention, the payment processing unit may generate a purchase confirmation request from the purchaser when the transmission of the big data is completed, and remit the payment to the big data seller only when a response to the purchase confirmation request is received.

In another aspect, a big data distribution brokerage method using data verification, includes: registering a big data seller using big data sales request information received from the big data seller; requesting basic metadata and sampling data of the big data from the registered big data seller, performing a verification on reliability of the big data by matching the basic metadata and the sampling data received in response to the request, and generating verification result information; generating big data sales list information using the verification result information and the big data sales request information when the reliability is recognized using the verification, and providing the generated big data sales list information to at least one purchaser; and determining a big data transmission method when a purchase request is received from the purchaser, and providing an online or offline path transmitting the big data possessed by the big data seller to the purchaser according to the determined big data transmission method.

According to an embodiment of the present invention, the generating of the verification result information may request structural characteristic information related to a structural characteristic of the big data from the registered big data seller, and determine types and sizes of basic metadata and sampling data of the big data requested to the registered big data seller according to the structural characteristic information.

According to an embodiment of the present invention, the generating of the verification result information may request structural characteristic information related to a structural characteristic of the big data from the registered big data seller, and determine a big data reliability verification method according to the structural characteristic information.

According to an embodiment of the present invention, the generating of the verification result information may perform the verification on the reliability of the big data every predetermined period, and update the generated verification result information.

According to an embodiment of the present invention, the providing of the generated big data sales list information to the at least one purchaser may add evaluation of the purchaser of the big data who previously purchased in the big data sales list information.

According to an embodiment of the present invention, the providing of the online or offline path may further include providing a big data transmission module to servers of the big data seller and the purchaser when the big data transmission method is determined to be an online transmission.

According to an embodiment of the present invention, the providing of the online or offline path may further include remitting payment to the big data seller when the payment is received from the purchaser before transmitting the big data and the transmission of the big data is completed.

According to an embodiment of the present invention, the remitting of the payment to the big data seller may generate a purchase confirmation request from the purchaser when the transmission of the big data is completed, and remit the payment to the big data seller only when a response to the purchase confirmation request is received.

Other features and aspects will be apparent from the following detailed description, the drawings, and the claims.

### BRIEF DESCRIPTION OF THE DRAWINGS

FIG. 1 is a diagram illustrating a connection among a big data distribution brokerage system using data verification, a big data seller, and a purchaser according to an embodiment of the present invention.

FIG. 2 is a diagram illustrating a configuration of a big data distribution brokerage system using data verification according to an embodiment of the present invention.

FIG. 3 is a diagram illustrating a data flow in a big data reliability verification operation according to an embodiment of the present invention.

FIG. 4 is a flowchart illustrating a big data distribution brokerage method using data verification according to an embodiment of the present invention.

FIG. 5 is a flowchart illustrating a big data reliability verification method according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, embodiments of the present invention will be described in detail with reference to the accompanying drawings to enable those of ordinary skill in the art to implement the present invention. However, the present invention may be implemented in many alternate forms, and should not be construed as limited to the embodiments set forth herein.

Further, in order to clearly describe the present invention, a portion which is not related to the description will be omitted, and throughout the specification, like reference numerals refer to like components.

Throughout the specification, when one component “comprises”, “includes”, or “has” another component, unless otherwise defined, it means that one or other components are not precluded but further included.

Hereinafter, a big data distribution brokerage system using data verification, and a method thereof according to an embodiment of the present invention will be described with reference to the accompanying drawings.

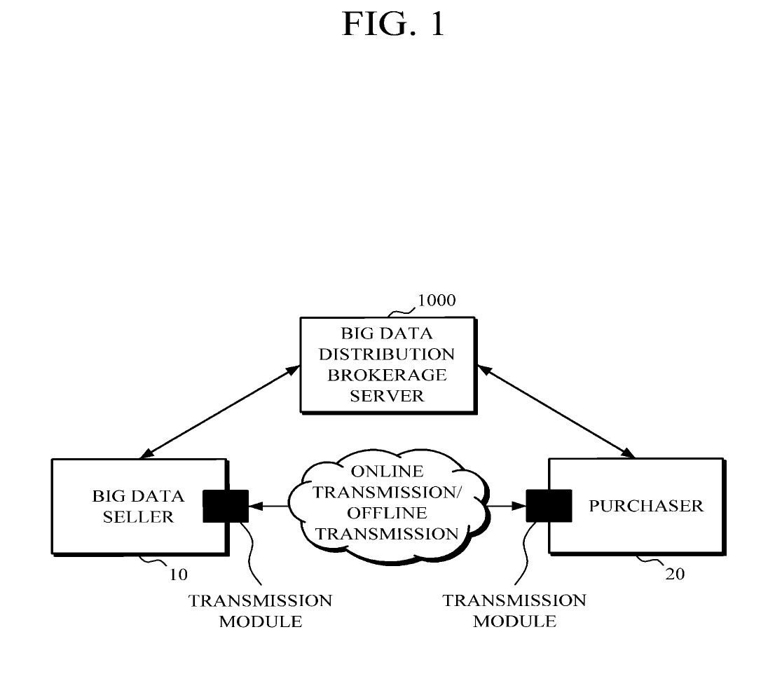

FIG. 1 is a diagram illustrating a connection among a big data distribution brokerage system 1000 using data verification, a big data seller 10, and a purchaser 20 according to an embodiment of the present invention.

Referring to FIG. 1, an example of a configuration in which a big data distribution brokerage system using data verification according to an embodiment of the present invention is connected to a big data seller and a purchaser is illustrated.

Referring to FIG. 1, the big data seller 10 who desires to sell big data may transmit a data sales request to the big data distribution brokerage system 1000 and register as the big data seller, and the big data purchaser 20 who desires to buy big data may search for the big data which is able to sell using big data sales list information generated by the big data distribution brokerage system 1000 and buy the desired big data.

According to an embodiment of the present invention, the big data distribution brokerage system 1000 may perform a verification operation on reliability of the big data in which the data sales is requested, for this, request basic metadata and sampling data of the big data from the big data seller 10, and receive data corresponding to the request.

According to an embodiment of the present invention, the big data distribution brokerage system 1000 may perform a payment operation when transacting the big data.

According to an embodiment of the present invention, there may be an online transmission and an offline transmission as a big data transmission method of the big data distribution brokerage system 1000, in the online transmission, the big data distribution brokerage system 1000 may allow the big data to be transmitted by providing a big data transmission module to servers of the big data seller 10 and the purchaser 20, and in the offline transmission, the data transmission method may be determined by consultation of the big data seller 10 and the purchaser 20, a specific transmission method may not be provided, and only a payment operation may be performed.

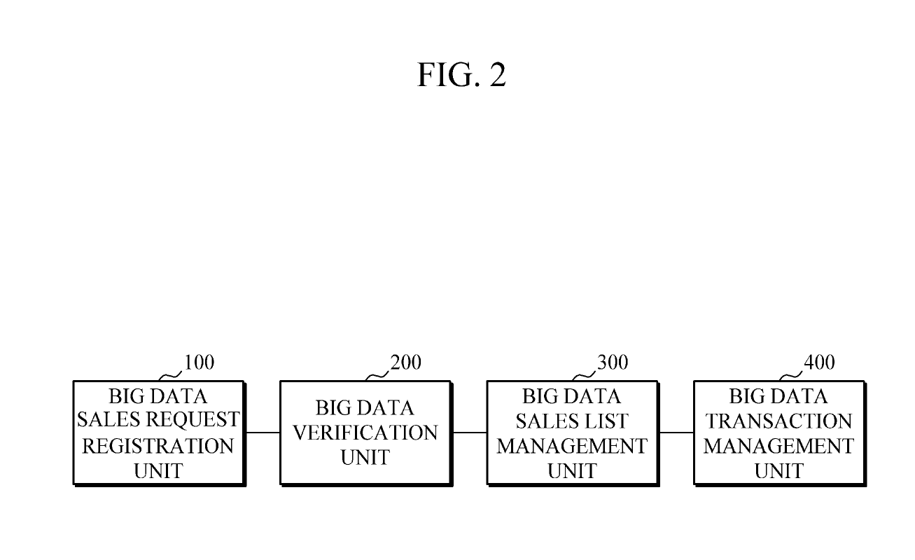

FIG. 2 is a diagram illustrating a configuration of the big data distribution brokerage system 1000 using data verification according to an embodiment of the present invention.

Referring to FIG. 2, the big data distribution brokerage system 1000 using data verification may include a big data sales request registration unit 100, a big data verification unit 200, a big data sales list management unit 300, and a big data transaction management unit 400.

The big data sales request registration unit 100 may register the big data seller using big data sales request information received from the big data seller.

Here, the big data sales request information may include information related to the big data seller, and simplified information related to the big data desired to sell.

According to an embodiment of the present invention, the big data sales request registration unit 100 may register the big data seller using the big data sales request information, generate big data verification request information, and transmit the generated big data verification request information to the big data verification unit 200.

The big data verification unit 200 may request the basic metadata and the sampling data of the big data from the registered big data seller, verify the reliability of the big data by matching the basic metadata and the sampling data received in response to the request, and generate verification result information.

According to an embodiment of the present invention, the big data verification unit 200 receiving the big data verification request information may request the basic metadata and the sampling data of the big data from the registered big data seller.

Here, the basic metadata of the big data may mean information on an attribute occupying a large proportion among large amounts of data configuring the big data.

Further, the sampling data may mean data occupying some portion of actual big data.

According to an embodiment of the present invention, since it is difficult to verify all the big data, the sampling data may be some portion of the big data which is arbitrarily selected by the big data seller, but is not limited thereto, and be some portion of the big data which is selected by a sampling tool provided by the big data distribution brokerage system 1000.

According to an embodiment of the present invention, a big data reliability verification method may be a method of determining the reliability according to whether attribute information included in the metadata and an attribute of the sampling data are identical by matching the received basic metadata and sampling data.

According to an embodiment of the present invention, structural characteristic information related to a structural characteristic of the big data may be requested to the registered big data seller, and the big data reliability verification method may be determined according to the structural characteristic information.

According to an embodiment of the present invention, the structural characteristic information related to the structural characteristic of the big data may mean information regarding whether the big data is in any state among a structured state, a semi-structured state, and an unstructured state.

According to an embodiment of the present invention, since data in the big data is aligned when the big data is in the structured state, it may be easy to understand a meaning of the data, and the verification of the big data may be easily performed by simply comparing with the basic metadata without a separate preprocessing.

On the other hand, since the data in the big data is less relatively aligned when the big data is in the semi-structured state compared with when the big data is in the structured state, a preprocessing needed for the alignment may be needed, and the verification of the big data may be simply performed by comparing with the basic metadata after performing the preprocessing.

Further, since the data in the big data is not aligned when the big data is in the unstructured state, the verification of the big data may be performed by comparing with the basic metadata after performing the alignment using a separate data processing for the alignment.

According to an embodiment of the present invention, the structural characteristic information related to the structural characteristic of the big data may be requested to the registered big data seller, and types and sizes of the basic metadata and the sampling data of the big data requested to the registered big data seller may be determined according to the structural characteristic information.

According to an embodiment of the present invention, since the data in the big data is aligned when the big data is in the structured state, it may be easy to understand an exact meaning of the data, and only the basic metadata and the sampling data of the big data having a relatively small number of types and sizes may be requested to the big data seller.

On the other hand, since the data in the big data is less relatively aligned when the big data is in the semi-structured state compared with when the big data is in the structured state, a preprocessing for the alignment may be needed, and the basic metadata and the sampling data of the big data having types and sizes of a degree to which the data is able to be aligned by performing preprocessing may be requested to the big data seller.

Further, since the data in the big data is not aligned when the big data is in the unstructured state, many samples may be needed in order to perform the alignment using a separate data processing for the alignment, and the basic metadata and the sampling data of the big data having a relatively large number of types and sizes may be requested to the big data seller.

According to an embodiment of the present invention, the big data reliability verification may be performed every predetermined period, and the generated verification result information may be updated.

According to an embodiment of the present invention, it may be determined that the big data has a reliability when the big data reliability verification is performed, but since it is difficult to maintain the reliability even after a predetermined time due to the characteristic of the big data in which the data is continuously accumulated and the size of the data is increased, the reliability of corresponding big data may be verified again the every predetermined period, and the verification result information may be updated according to the verification result.

The big data sales list management unit 300 may generate the big data sales list information using the verification result information and the big data sales request information when the reliability is recognized using the verification, and provide the generated big data sales list information to at least one purchaser.

Here, the big data sales list information may mean contents related to the big data which may be a reference of selection when the purchaser wants to buy the big data, and according to an embodiment of the present invention, may include contents, a collection purpose, a collection agency, a collection method, a use, a capacity, a type, or seller information of the big data, but is not limited thereto, and any information which is helpful when indentifying and selecting the big data in which the purchaser wants to buy may be included in the big data sales list information without limitations.

According to an embodiment of the present invention, evaluation of the big data purchaser who has previously purchased may be further included in the big data sales list information.

Here, the big data purchaser who has previously purchased may mean a purchaser who has previously purchased corresponding big data, and evaluation of the purchaser who has purchased the big data from a corresponding big data seller may be further included in the big data sales list information.

The big data transaction management unit 400 may determine a big data transmission method when the sales request is received from the purchaser, and provide an online or offline path of transmitting the big data possessed by the big data seller to the purchaser according to the determined big data transmission method.

According to an embodiment of the present invention, one of predetermined transmission methods in order to determine the big data transmission method may be a method in which a corresponding transmission method is determined when an opponent accepts after the seller or the purchaser selects and transmits the transmission method to the opponent, but is not limited thereto, and any big data transmission method capable of being determined by consultation of the seller and the purchaser may be used without limitations.

According to an embodiment of the present invention, when the big data transmission method is determined to be the offline transmission, the big data may be transmitted in a method determined by the consultation of the big data seller and the purchaser among the predetermined offline transmission methods, and according to an embodiment of the present invention, the big data may be directly transmitted by being stored in a universal serial bus (USB) or an external hard disk, and being transmitted by a parcel service or a mail.

According to an embodiment of the present invention, when the big data transmission method is determined to be the online transmission, a transmission module support unit 410 providing the big data transmission module to the servers of the big data seller and the purchaser may be further included.

Here, the big data transmission module may mean a module of connecting a terminal of the big data seller and a terminal of the purchaser and forming a path capable of transmitting the data.

According to an embodiment of the present invention, a payment processing unit 420 may be further included to remit payment to the big data seller when the payment is received from the purchaser before transmitting the big data and the transmission of the big data is completed.

According to an embodiment of the present invention, the payment processing unit 420 may generate a purchase confirmation request from the purchaser when the transmission of the big data is completed, and remit the payment to the big data seller only when a response to the purchase confirmation request is received.

According to an embodiment of the present invention, the big data may be encrypted using an encryption tool provided by the big data distribution brokerage system 1000, the encrypted big data may be transmitted to the purchaser, and the big data distribution brokerage system 1000 may transmit a data encryption key to the purchaser and request the purchase confirmation when the transmission of the big data is completed, and remit the payment to the big data seller only when the response to the purchase confirmation request is received.

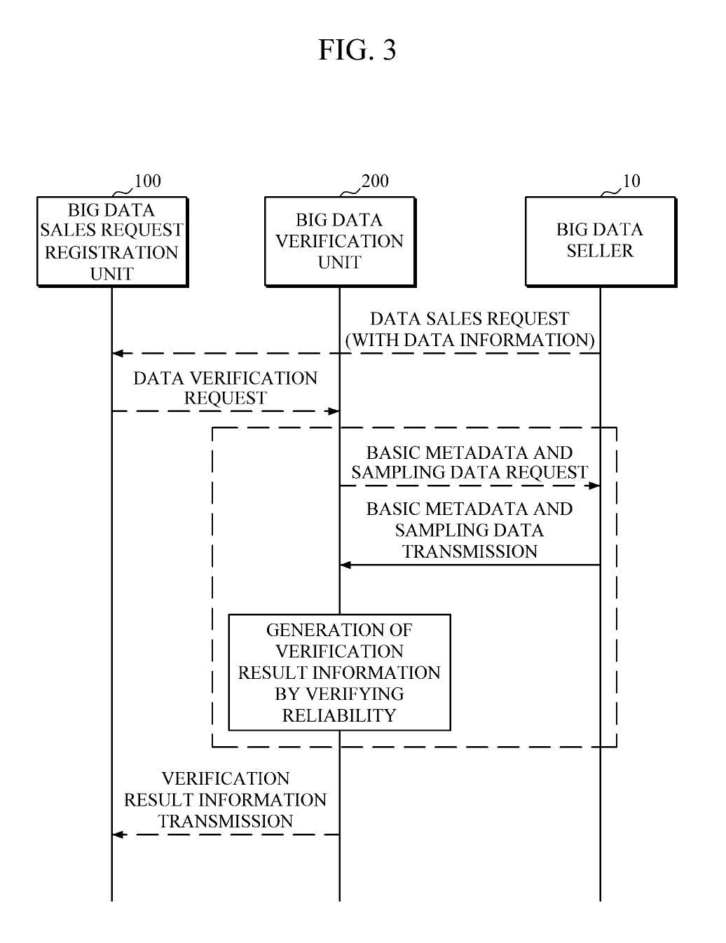

FIG. 3 is a diagram illustrating a data flow in a big data reliability verification operation according to an embodiment of the present invention.

Referring to FIG. 3, in order to sell the big data, the big data seller 10 may transmit the big data sales request information to the big data sales request registration unit 100, and register the big data seller.

In this case, the big data sales request registration unit 100 may request the verification of the big data from the big data verification unit 200, and the big data verification unit 200 may request the basic metadata and the sampling data of the big data from the big data seller 10.

The big data seller 10 to which the basic metadata and the sampling data of the big data are requested may transmit corresponding basic metadata and sampling data to the big data verification unit 200, and the big data verification unit 200 may verify the reliability of the big data using the transmitted basic metadata and sampling data, generate the verification result information, and transmit the generated verification result information to the big data sales list management unit 300.

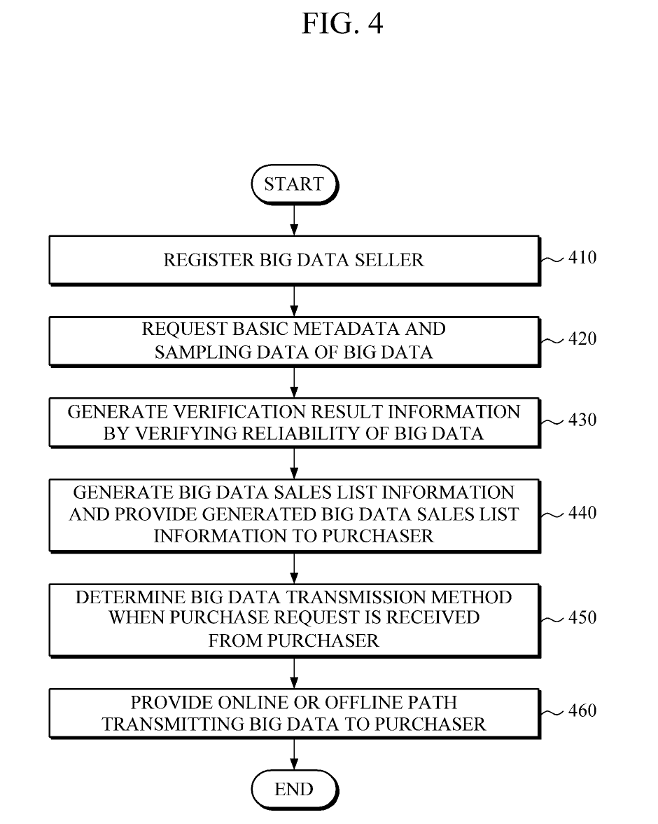

FIG. 4 is a flowchart illustrating a big data distribution brokerage method using data verification according to an embodiment of the present invention.

The big data seller may be registered (S410).

According to an embodiment of the present invention, the big data seller may be registered using the big data sales request information received from the big data seller.

Here, the big data sales request information may include information related to the big data seller, and simplified information on the big data desired to sell.

According to an embodiment of the present invention, the big data seller may be registered using the big data sales request information, and the big data verification request information may be generated.

The basic metadata and the sampling data of the big data may be requested (S420).

According to an embodiment of the present invention, the basic metadata and the sampling data of the big data may be requested to the big data seller.

According to an embodiment of the present invention, when the big data verification request information is received, the basic metadata and the sampling data of the big data may be requested to the registered big data seller.

Here, the basic metadata of the big data may mean information on an attribute occupying a large proportion among large amounts of data configuring the big data.

Further, the sampling data may mean data occupying some portion of actual big data.

According to an embodiment of the present invention, since it is difficult to verify all the big data, the sampling data may be some portion of the big data which is arbitrarily selected by the big data seller, but is not limited thereto, and be some portion of the big data which is selected by the sampling tool.

Verification result information may be generated by verifying the reliability of the big data (S430).

According to an embodiment of the present invention, a big data reliability verification method may be a method of determining the reliability according to whether attribute information included in the metadata and an attribute of the sampling data are identical by matching the received basic metadata and sampling data.

According to an embodiment of the present invention, structural characteristic information related to a structural characteristic of the big data may be requested to the registered big data seller, and the big data reliability verification method may be determined according to the structural characteristic information.

According to an embodiment of the present invention, the structural characteristic information related to the structural characteristic of the big data may mean information regarding whether the big data is in any state among a structured state, a semi-structured state, and an unstructured state.

According to an embodiment of the present invention, since data in the big data is aligned when the big data is in the structured state, it may be easy to recognize an exact meaning of the data, and the verification of the big data may be easily performed by simply comparing with the basic metadata without a separate preprocessing.

On the other hand, since the data in the big data is less relatively aligned when the big data is in the semi-structured state compared with when the big data is in the structured state, a preprocessing needed for the alignment may be needed, and the verification of the big data may be simply performed by comparing with the basic metadata after performing the preprocessing.

Further, since the data in the big data is not aligned when the big data is in the unstructured state, the verification of the big data may be performed by comparing with the basic metadata after performing the alignment using a separate data processing for the alignment.

According to an embodiment of the present invention, the structural characteristic information related to the structural characteristic of the big data may be requested to the registered big data seller, and types and sizes of the basic metadata and the sampling data of the big data requested to the registered big data seller may be determined according to the structural characteristic information.

According to an embodiment of the present invention, since the data in the big data is aligned when the big data is in the structured state, it may be easy to recognize an exact meaning of the data, and only the basic metadata and the sampling data of the big data having a relatively small number of types and sizes may be requested to the big data seller.

On the other hand, since the data in the big data is less relatively aligned when the big data is in the semi-structured state compared with when the big data is in the structured state, a preprocessing for the alignment may be needed, and the basic metadata and the sampling data of the big data having types and sizes of a degree to which the data is able to be aligned by performing preprocessing may be requested to the big data seller.

Further, since the data in the big data is not aligned when the big data is in the unstructured state, many samples may be needed in order to perform the alignment using a separate data processing for the alignment, and the basic metadata and the sampling data of the big data having a relatively large number of types and sizes may be requested to the big data seller.

According to an embodiment of the present invention, the big data reliability verification may be performed every predetermined period, and the generated verification result information may be updated.

According to an embodiment of the present invention, it may be determined that the big data has a reliability by performing the big data reliability verification, but since it is difficult to maintain the reliability even after a predetermined time due to the characteristic of the big data in which the data is continuously accumulated and the size of the data is increased, the reliability of corresponding big data may be verified again the every predetermined period, and the verification result information may be updated according to the verification result.

Big data sales list information may be generated, and provided to the purchaser (S440).

According to an embodiment of the present invention, when the reliability is recognized using the verification, the big data sales list information may be generated using the big data verification result information and the big data sales request information, and the generated big data sales list information may be provided to at least one purchaser.

Here, the big data sales list information may mean contents related to the big data which may be a reference of selection when the purchaser wants to buy the big data, according to an embodiment of the present invention, may include contents, a collection purpose, a collection agency, a collection method, a use, a capacity, a type, or seller information of the big data, but is not limited thereto, and any information which is helpful when indentifying and selecting the big data in which the purchaser wants to buy may be included in the big data sales list information without limitations.

According to an embodiment of the present invention, evaluation of the big data purchaser who has previously purchased may be further included in the big data sales list information.

Here, the big data purchaser who has previously purchased may mean a purchaser who has previously purchased corresponding big data, and evaluation of the purchaser who has purchased the big data from a corresponding big data seller may be further included.

A big data transmission method may be determined when the purchase request is received from the purchaser (S450).

According to an embodiment of the present invention, one of predetermined transmission methods in order to determine the big data transmission method may be a method in which a corresponding transmission method is determined when an opponent accepts after the seller or the purchaser selects and transmits the transmission method to the opponent, but is not limited thereto, and any big data transmission method capable of being determined by consultation of the seller and the purchaser may be used without limitations.

A process of transmitting possessed big data to the purchaser may be provided according to the determined big data transmission method (S460).

According to an embodiment of the present invention, when the big data transmission method is determined to be the offline transmission, the big data may be transmitted in a method determined by the consultation of the big data seller and the purchaser among the predetermined offline transmission methods, and according to an embodiment of the present invention, the big data may be directly transmitted by being stored in a USB or an external hard disk, and being transmitted by a parcel service or a mail.

According to an embodiment of the present invention, when the big data transmission method is determined to be the online transmission, a big data transmission module may be provided to the servers of the big data seller and the purchaser.

Here, the big data transmission module may mean a module of connecting a terminal of the big data seller and a terminal of the purchaser and forming a path capable of transmitting the data.

According to an embodiment of the present invention, payment may be remitted to the big data seller when the payment is received from the purchaser before transmitting the big data and the transmission of the big data is completed.

According to an embodiment of the present invention, a purchase confirmation request may be generated from the purchaser when the transmission of the big data is completed, and the payment may be remitted to the big data seller only when a response to the purchase confirmation request is received.

According to an embodiment of the present invention, the big data may be encrypted using an encryption tool, the encrypted big data may be transmitted to the purchaser, and a data encryption key may be transmitted to the purchaser and the purchase confirmation may requested when the transmission of the big data is completed, and the payment may be remitted to the big data seller only when the response to the purchase confirmation request is received.

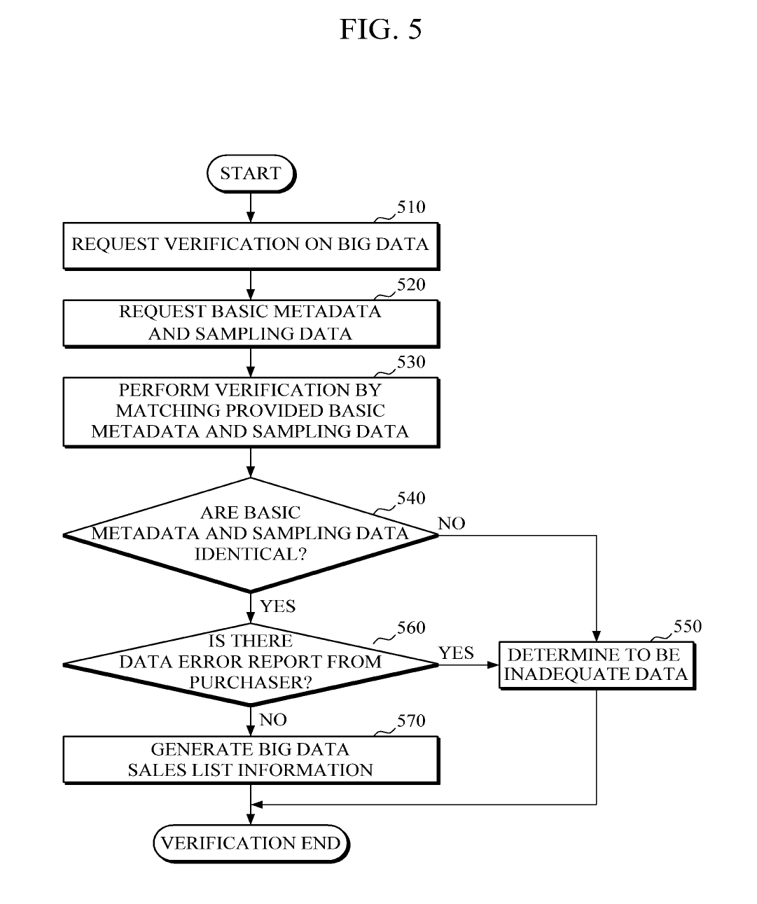

FIG. 5 is a flowchart illustrating a big data reliability verification method according to an embodiment of the present invention.

When the verification of the big data is requested (S510), the basic metadata and the sampling data of the big data may be requested (S520), and the reliability of the big data may be verified by matching the received basic metadata and the sampling data in response to the request (S530).

When the reliability of the big data is recognized based on the verification result, the verification result information may be generated (S540), and when the reliability is not recognized, the verification may be ended.

In this case, it may be determined whether there is a data error report of the purchaser (S560), the big data sales list information may be generated using the verification result information and the big data sales request information when there is no error report and the generated big data sales list information may be provided to at least one purchaser (S570), and the verification may be ended when there is the error report.

According to an embodiment of the present invention, when desiring to buy and sell big data, the big data desired to be transacted may be safely transacted without separately storing in a brokerage side by using only minimal sampling data and verifying the reliability of the big data, and thus a low cost and a high security may be provided since a separate brokerage server having a large capacity is not required.

Embodiments of the present invention are not implemented using only the apparatus and/or the method described herein. While the embodiments of the present are described in detail, the scope of the present invention is not limited thereto, and may include various changes and modifications implemented by those of ordinary skill in the art using a basic concept of the present invention defined in the following claims.

What is claimed is:

1. A big data distribution brokerage system using data verification, comprising:
a big data sales request registration unit configured to register a big data seller using big data sales request information received from the big data seller;
a big data verification unit configured to request basic metadata and sampling data of the big data from the registered big data seller, perform a verification on reliability of the big data by matching the basic metadata and the sampling data received in response to the request, and generate verification result information;
a big data sales list management unit configured to generate big data sales list information using the verification result information and the big data sales request information when the reliability is recognized using the verification, and provide the generated big data sales list information to at least one purchaser; and
a big data transaction management unit configured to determine a big data transmission method when a purchase request is received from the purchaser, and provide an online or offline path transmitting the big data possessed by the big data seller to the purchaser according to the determined big data transmission method.

2. The big data distribution brokerage system using the data verification of claim 1, wherein the big data verification unit requests structural characteristic information related to a structural characteristic of the big data from the registered big data seller, and determines types and sizes of basic metadata and sampling data of the big data requested to the registered big data seller according to the structural characteristic information.

3. The big data distribution brokerage system using the data verification of claim 1, wherein the big data verification unit requests structural characteristic information related to a structural characteristic of the big data from the registered big data seller, and determines a big data reliability verification method according to the structural characteristic information.

4. The big data distribution brokerage system using the data verification of claim 1, wherein the big data verification unit performs the verification on the reliability of the big data every predetermined period, and updates the generated verification result information.

5. The big data distribution brokerage system using the data verification of claim 1, wherein the big data sales list management unit adds evaluation of the purchaser of the big data who previously purchased in the big data sales list information.

6. The big data distribution brokerage system using the data verification of claim 1, wherein the big data transaction management unit further comprises a transmission module support unit configured to provide a big data transmission module to servers of the big data seller and the purchaser when the big data transmission method is determined to be an online transmission.

7. The big data distribution brokerage system using the data verification of claim 1, wherein the big data transaction management unit further comprises a payment processing unit configured to remit payment to the big data seller when the payment is received from the purchaser before transmitting the big data and the transmission of the big data is completed.

8. The big data distribution brokerage system using the data verification of claim 7, wherein the payment processing unit generates a purchase confirmation request from the purchaser when the transmission of the big data is completed, and remits the payment to the big data seller only when a response to the purchase confirmation request is received.

9. A big data distribution brokerage method using data verification, comprising:
registering a big data seller using big data sales request information received from the big data seller;
requesting basic metadata and sampling data of the big data from the registered big data seller, performing a verification on reliability of the big data by matching the basic metadata and the sampling data received in response to the request, and generating verification result information;
generating big data sales list information using the verification result information and the big data sales request information when the reliability is recognized using the verification, and providing the generated big data sales list information to at least one purchaser; and
determining a big data transmission method when a purchase request is received from the purchaser, and providing an online or offline path transmitting the big data possessed by the big data seller to the purchaser according to the determined big data transmission method.

10. The big data distribution brokerage method using the data verification of claim 9, wherein the generating of the verification result information requests structural characteristic information related to a structural characteristic of the big data from the registered big data seller, and determines types and sizes of basic metadata and sampling data of the big data requested to the registered big data seller according to the structural characteristic information.

11. The big data distribution brokerage method using the data verification of claim 9, wherein the generating of the verification result information requests structural characteristic information related to a structural characteristic of the big data from the registered big data seller, and determines a big data reliability verification method according to the structural characteristic information.

12. The big data distribution brokerage method using the data verification of claim 9, wherein the generating of the verification result information performs the verification on the reliability of the big data every predetermined period, and updates the generated verification result information.

13. The big data distribution brokerage method using the data verification of claim 9, wherein the providing of the generated big data sales list information to the at least one purchaser adds evaluation of the purchaser of the big data who previously purchased in the big data sales list information.

14. The big data distribution brokerage method using the data verification of claim 9, wherein the providing of the online or offline path further comprises providing a big data transmission module to servers of the big data seller and the purchaser when the big data transmission method is determined to be an online transmission.

15. The big data distribution brokerage method using the data verification of claim 9, wherein the providing of the online or offline path further comprises remitting payment to the big data seller when the payment is received from the purchaser before transmitting the big data and the transmission of the big data is completed.

16. The big data distribution brokerage method using the data verification of claim 15, wherein the remitting of the payment to the big data seller generates a purchase confirmation request from the purchaser when the transmission of the big data is completed, and remits the payment to the big data seller only when a response to the purchase confirmation request is received.
